(19) United States
(12) Patent Application Publication
(10) Pub. No.: US 2009/0014671 A1
(43) Pub. Date: Jan. 15, 2009

(54) Cryogenic Solenoid Valve

(75) Inventors: Laurent Allidieres, Saint Martin D'Uriage (FR); Florent Janin, Hangzhou (CN)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Ex ploitation Des Procedes Georges Claude, Paris, Cedex 7 (FR)

(21) Appl. No.: 12/088,317

(22) PCT Filed: Aug. 3, 2006
(86) PCT No.: PCT/FR2006/050782

§ 371 Date: Sep. 5, 2008

(30) Foreign Application Priority Data
Sep. 27, 2005 (FR) 0552885

(51) Int. Cl. F16K 31/06

(52) U.S. Cl. 251/65

(57) ABSTRACT

Solenoid valve including a seat body connected via an elongate tube to a valve head supporting the electromagnetic actuator, wherein said valve head is sealingly mounted in a wall of an evacuated valve box insulating the tube and the seat body from the outside. The invention is useful in particular in controlling a flow of cryogenic fuel, specifically liquid hydrogen, in a motor vehicle.

The present invention relates to cryogenic solenoid valves that can be used to control a flow of cryogenic fluid, particularly of cryogenic fuel contained in a tank of a motor vehicle using said fuel, particularly for its propulsion.

In the following description, reference will be made essentially, although in a nonlimiting manner, to the use of valves for tanks for storing motor vehicle liquid hydrogen used in a fuel cell and/or directly as a fuel in an internal combustion engine.

Liquid hydrogen tanks, insulated under vacuum, contain between 5 and 13 kg of liquid hydrogen, at a temperature of 20 K and at pressures typically lying between 1 and 13 bar. Typically, a motor vehicle liquid hydrogen tank comprises a filling line, a gas outlet line and a liquid outlet line. Valves controlling the flows of gases containing hydrogen in each line are conventionally installed in an enclosure under vacuum called a “valve box” in order to thermally insulate the circuits of cold fluid at 20 K from the ambient temperature.

Hitherto, (as described for example in EP-A-0 779 468 Messer/BMW), solenoid valves have been placed entirely in the valve box under vacuum, which poses problems of access to the electric portion of the valve in the case of a defect on the coil, problems of access to the gate element in the event of a leak, and problems of quality of the vacuum of the valve box because the coils “degas” when they are open, because of the heat emitted by the coil.

The object of the present invention is to propose a cryogenic solenoid valve architecture preventing the above problems, being suited in particular for mass market motor vehicle uses with increased reliability and a minimum space requirement.

To do this, according to the invention, the solenoid valve comprises a seat body that can be inserted into a fluid circuit and that forms a gate seat, a gate kit comprising a gate element interacting with the seat and connected via a stem to an electromagnetic actuator, the actuator being mounted on a first end of a tubular barrel enclosing the gate kit and whose second end is attached to the seat body.

According to other more particular features of the invention:
the gate element has a tubular shape enclosing one end of the stem and mounted so as to slide in a sealed manner in a bore of the seat body,
the second end of the barrel is mounted on a protruding tubular portion of the seat body partly defining the bore,
the first end of the barrel is connected to a tubular valve head partly enclosing a plunger of the actuator interacting with the stem and comprising a collar for mounting in a wall of an enclosure under vacuum enclosing the barrel and the seat body.

The present invention also relates to the use of such a cryogenic solenoid valve to control the flow of cryogenic fuel (fuel oil) contained in a tank, particularly a motor vehicle tank.

Finally the present invention relates to a motor vehicle fuel tank fitted with a valve box under vacuum and at least one solenoid valve as defined above.

Other features and advantages of the invention will emerge from the following description of embodiments given as an illustration but in no way limiting, made with reference to the appended drawings, in which:

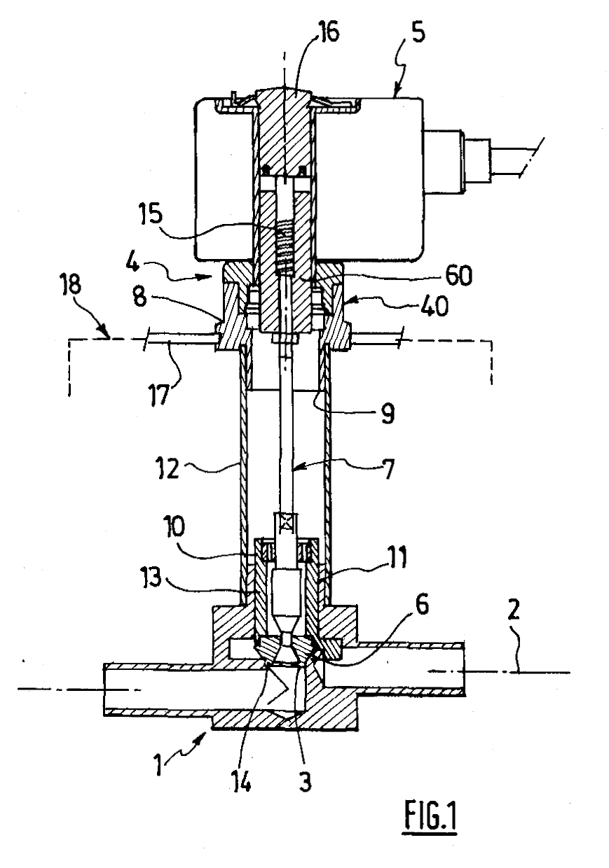

FIG. 1 is a view in longitudinal section of a solenoid valve according to the invention,

FIG. 2 is a schematic top view of a pair of solenoid valves according to FIG. 1 on a valve box under vacuum; and

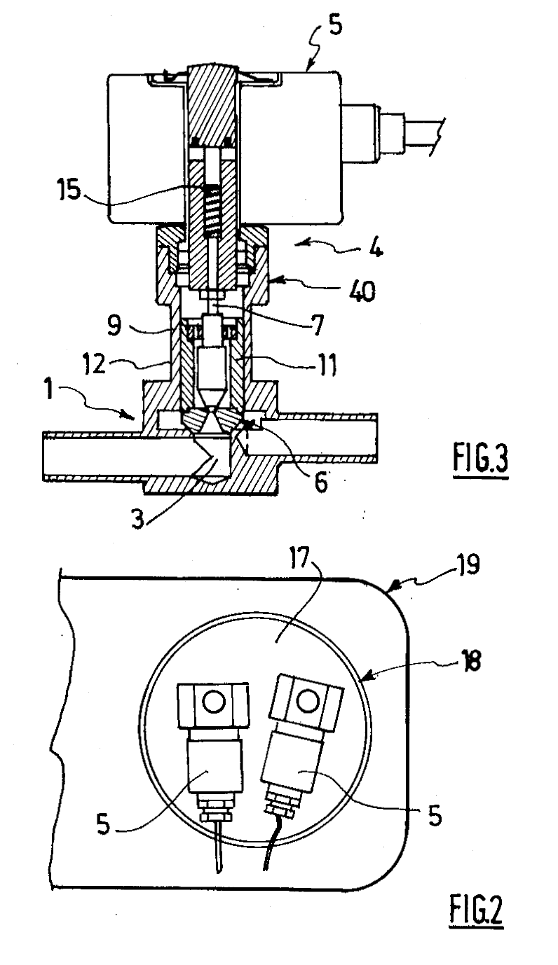

FIG. 3 is a view similar to FIG. 1 showing the possibility of using the solenoid valve according to the invention for noncryogenic fluids.

As shown in FIG. 1, the solenoid valve according to the invention essentially comprises a seat body 1 that can be inserted into a fluid circuit 2, typically a circuit for supplying a driving member of a motor vehicle with cryogenic fluid, and forming a seat 3, a valve head 4 supporting an electromagnetic actuator 5 and a gate kit comprising a gate head 6 connected via a stem 7 made of a material that slightly conducts heat and is nonmagnetic, for example made of heavily alloyed stainless steel, to the magnetic core 60 of the actuator 5.

More specifically, the valve head 4 comprises a lower tubular part 40 comprising a collar 8 extending radially outward and a tubular end portion 9.

The seat body 1 comprises, coaxially with the seat 3, a bore 10 formed partly in a tubular portion 11 extending outward.

A long tube 12, sleeve-fitted in a sealed manner to the tubular portions 9 and 11 while coaxially enclosing the stem 7, connects the valve head 4 to the seat body 1. The tube 12 typically has a length that is between three and five times its diameter.

The gate head 6 comprises a tubular part 13 mounted so as to slide in a sealed manner in the bore 10 and a frustoconical end part 14, forming the actual gate, interacting with the seat 3 and connected to the bottom end of the stem 7.

The upper end of the stem 7 is connected to the core 60, that is moved, in the direction of closure of the gate 6 against the seat 3, by a spring 15 pressing on the pole shoe 16 of the actuator 5.

As shown in FIG. 1, in the preferred application of controlling a flow of ultra-cold fluid according to the invention, the collar 8 of the part 40 of the solenoid valve head 4 is used for mounting the solenoid valve in a sealed manner in the wall 17 of a valve box 18 under vacuum, also visible in FIG. 2, associated with a cryogenic fluid tank 19, particularly a liquid hydrogen tank of a motor vehicle.

From the foregoing description, it will be understood that, with the solenoid valve arrangement according to the invention, the coil of the actuator 5 is situated outside the valve box 18, so is accessible easily and at ambient temperature without affecting the quality of the inter-wall vacuum when it is activated. By unscrewing the upper portion of the head 4 and removing the actuator/gate kit assembly, it is possible to gain direct access to the seat 3 in the case of a leak without having to break the enclosure under vacuum. The seat 3 in the seat body 1 is always situated in the valve box 18 under vacuum while being permanently separated from the ambient atmosphere. On the other hand, the coil of the actuator 5, using epoxy resin, is protected from thermal shocks due to very low temperature cryogenic fluid traveling in the seat body 1. Advantageously, the sealed mount 40 of the valve head 4 on the valve box 18 is designed to remain sealed also at the cryogenic temperatures of the fluid traveling in the circuit 2 (in the event of an accident with the vehicle overturning, for example).

As shown in FIG. 3, the solenoid valve architecture according to the invention is also suitable to be used in noncryogenic surroundings, in the absence of any valve box under vacuum. In this case, the stainless steel tube 12 is removed and replaced for example by an extension of the annular end portion 9 of the valve head 4 being mounted directly on the tubular portion 11 of the seat body 1, the stem 7 in this instance having an extremely reduced extension and being able to be made of any appropriate materials.

Although the invention has been described with reference to particular embodiments, it is not limited thereto but is capable of modifications and variants that will appear to those skilled in the art in the context of the following claims.

1-12. (canceled)

13. A cryogenic solenoid valve comprising:
a seat body that can be inserted into a fluid circuit and that forms a seat
a gate kit comprising a gate element interacting with the seat and connected via a stem to an electromagnetic actuator,
the actuator being mounted on a first end of a tubular barrel partly enclosing the gate kit and whose second end is attached to the seat body, characterized in that the first end of the barrel is connected to a tubular valve head partly enclosing a plunger of the actuator interacting with the stem and comprising a collar for mounting in a wall of an enclosure under vacuum enclosing the barrel and the seat body.

14. The solenoid valve of claim 13, characterized in that the gate element has a tubular shape enclosing one end of the stem and mounted so as to slide in a sealed manner in a bore of the seat body.

15. The solenoid valve of claim 14, characterized in that one end of the tubular part forming the gate element is closed at one end by an end part, that is frustoconical for example, forming the actual valve designed to interact with the seat.

16. The solenoid valve of claim 15, characterized in that the end part is connected to the bottom end of the stem.

17. The solenoid valve of claim 14, characterized in that the second end of the barrel is mounted on a protruding tubular portion of the seat body partly defining the bore.

18. The solenoid valve of claim 13, characterized in that the barrel is formed in a single piece with the valve head.

19. The solenoid valve of claim 13, characterized in that the barrel consists of a long tube.

20. The solenoid valve of claim 13, characterized in that the collar is situated outside the portion under vacuum in order to allow the assembly comprising the stem and the gate to be completely removed.

21. The solenoid valve of claim 13, characterized in that the upper portion of the valve head can be removed, relative to the collar, by unscrewing, in order to allow the actuator/gate kit assembly to be removed and to allow direct access to the seat.

22. The use of the solenoid valve of claim 13 to control the flow of a cryogenic fuel contained in a tank.

23. A motor vehicle fuel oil tank comprising a valve box under vacuum and the solenoid valve of claim 13.

24. The tank of claim 23, characterized in that the cryogenic fuel is liquid hydrogen.

25. The solenoid valve of claim 15, characterized in that the second end of the barrel is mounted on a protruding tubular portion of the seat body partly defining the bore.
